(19) United States
(12) Patent Application Publication
(10) Pub. No.: US 2026/0209635 A1
(43) Pub. Date: Jul. 23, 2026

(54) Opacifying compositions for cleaning formulations

(71) Applicant: SPECIALTY OPERATIONS FRANCE, Lyon (FR)

(72) Inventors: Sujandi ZHOU, Singapore (SG); Wenting SHEN, Shanghai (CN); Celine ORIZET, Aubervilliers Cedex (FR); Ricardo MINGOT, Aubervilliers Cedex (FR)

(21) Appl. No.: 19/141,270

(22) PCT Filed: Dec. 26, 2022
(86) PCT No.: PCT/CN2022/141891

§ 371 Date: Jun. 19, 2025

(51) Int. Cl. C11D 1/86; C11D 1/02; C11D 1/66; C11D 1/88; C11D 3/04; C11D 3/10; C11D 3/12; C11D 3/382

(52) U.S. Cl. CPC C11D 1/86; C11D 1/02; C11D 1/66; C11D 1/88; C11D 3/046; C11D 3/10; C11D 3/1213; C11D 3/122; C11D 3/1253; C11D 3/382

(57) ABSTRACT

Compositions comprising an opacifying mineral having a refractive index of at least 1.40 and a density of 1.5 g/cm³ to 6 g/cm³, preferably of 1.5 g/cm³ to 4 g/cm³, microfibrous cellulose; and optionally a surfactant are disclosed.

### TECHNICAL FIELD

The present invention generally relates to compositions comprising an opacifying mineral and microfibrous cellulose (MFC). More specifically, the present invention relates to compositions comprising an opacifying mineral having a given refractive index and density, which along with the MFC provides the compositions with excellent opaqueness and whiteness properties.

### TECHNICAL BACKGROUND

Microplastic particles can generally be used in compositions, and in particular home and personal care products, to opacify or whiten the same. In particular, the microplastic particles act as an opacifier, which imparts a uniform, lotionized, and white appearance in the formulation. With respect to home and personal care products, synthetic microplastic particles, such as styrene arcrylate copolymers, are used in liquid cleaning products, such as shower gels and shampoo formulations.

However, the use of microplastic particles in home and personal care products is not environmentally friendly since the particles are synthetic and are not biodegradable. Furthermore, flocculation, sedimentation, or both can occur in products containing the microplastic particles, and in particular under high temperatures or during extended storage.

Therefore, it is an object of the present invention to provide environmentally friendly compositions for cleaning or washing, and in particular liquid home and personal care products, that are stable at high temperatures for extended storage times, which also have a uniform white and opaque appearance without the drawbacks of using microplastic particles.

### SUMMARY OF THE INVENTION

The present invention generally relates to compositions comprising:
(a) an opacifying mineral having a refractive index of at least 1.40 and a density of 1.5 g/cm³ to 6 g/cm³, preferably of 1.5 g/cm³ to 4 g/cm³;
(b) microfibrous cellulose; and optionally
(c) a surfactant.

The present invention also generally relates to the use of such compositions as cleaning compositions, preferably as liquid laundry compositions, single unit dose, liquid laundry detergent compositions, dishwashing compositions, personal care compositions (preferably as a body cleaning composition, facial cleaning composition, shampoo, skin composition, or combination thereof), disinfection compositions, floor cleansers, toilet bowl cleansers, and glass cleansers.

### DETAILED DESCRIPTION OF THE INVENTION

The following definitions are relevant in connection with the embodiments of the present invention.

The meaning of the term “comprising” is to be interpreted as encompassing all the specifically mentioned features as well optional, additional, unspecified ones, whereas the term “consisting of” only includes those features as specified. Therefore, “comprising” includes as a limiting case the composition specified by “consisting of”.

The term “wt. %” refers to the amount of the respective ingredient by weight based on the total amount of the composition, unless noted otherwise.

As used herein, the singular forms “a”, “an”, and “the” include both singular and plural referents unless the context clearly dictates otherwise. By way of example, “an opacifying mineral” means one opacifying mineral or more than one opacifying mineral.

The term “opacifying mineral” is not particularly limited. An opacifying mineral is a mineral that is opaque, i.e. non-transparent. Opacifying minerals may have an extinction coefficient & at 550 nm of 0.5 L/g/cm or more.

Unless noted otherwise, “the composition” and the plural thereof refers to the composition and compositions of the present invention, including all the embodiments therein.

Embodiments, including any and all preferred embodiments, according to the invention are defined hereinafter. The embodiments can be alone or in combination. Further, it is to be understood that the following embodiments refer to all aspects of the present invention, which includes the compositions as well as the use of the compositions.

In one embodiment, the present invention relates to a composition comprising:
(a) an opacifying mineral having a refractive index of at least 1.40 and a density of 1.5 g/cm³ to 6 g/cm³, preferably of 1.5 g/cm³ to 4 g/cm³;
(b) microfibrous cellulose; and
(c) optionally, a surfactant.

It has been found that the compositions of the present invention have excellent whiteness and uniformity, while also having excellent stability. In this respect, in certain embodiments, it has been found that such compositions are stable at high temperatures for extended storage times and no flocculation or sedimentation occurs during storage. This is particularly surprising since it is generally known that mineral dispersions, especially in liquid home and personal care compositions, can be difficult to stabilize, particularly for long storage periods at high temperatures. Further, since the compositions comprise an opacifying mineral, as opposed to microplastic particles, the compositions of the present invention are more environmentally friendly than those that have microplastic particles.

In general, the refractive index of the opacifying mineral can be obtained from a refractive index database or references, such as the Handbook of Optical Constants of Solids, vol. 2, ed. Edward D. Palik (1991). The refractive index of the opacifying mineral may also be measured according to GB/T 16863-1997. In certain embodiments, preference is given to measuring the refractive index in accordance with GB/T 16863-1997. The upper limit for the refractive index of the opacifying mineral is not particularly limited. In a preferred embodiment, the refractive index of the opacifying mineral is lower than 3.50, lower than 3.00, or lower than 2.50. In an embodiment, the refractive index is at least 1.40, at least 1.45, or at least 1.50. The refractive index of the opacifying mineral is separate from the refractive index of the composition having the opacifying mineral. In this respect, the composition can have the same refractive index as the opacifying mineral or a different refractive index. In certain embodiments, compositions comprising the opacifying mineral can have a refractive index of at least 1.20, at least 1.25, or at least 1.30. Further, in certain embodiments, compositions comprising the opacifying mineral can have a refractive index of 2.50 or less, preferably 2.45 or less. In this respect, the compositions comprising the opacifying mineral can have a refractive index ranging from at least 1.20 to 2.50, preferably 1.25 to 2.50, and even 1.30 to 2.50. In other embodiments, the compositions comprising the opacifying mineral can have a refractive index ranging from at least 1.20 to 2.45, preferably 1.25 to 2.45, and even 1.30 to 2.45.

The refractive index of the composition, which comprises the opacifying mineral, may be measured by a refractometer. In this respect, conventional and commercial refractometers can be used. In certain embodiments, the refractometer can be a Bellingham+Stanley refractometer, and in particular can be a Bellingham+Stanley refractometer RFM870. The refractive index can be determined following the operating procedures according to the specific refractometer.

The density of the opacifying mineral refers to the density of the opacifying material in continuous form. The term “density” with respect to the opacifying material thus does not refer to bulk density of the material, which takes into account porosity of the opacifying mineral in powder form. In certain embodiments, the density of the opacifying mineral can generally be obtained from references and textbooks, such as Römpps Chemistry Lexicon and from the International Centre for Diffraction Data (ICDD). The density of the opacifying mineral can also be measured according to ASTM D 5965-19. In certain embodiments, preference is given to measuring the density in accordance with ASTM D 5965-19.

The density of the opacifying mineral is from 1.5 g/cm³ to 6 g/cm³, preferably from 1.5 g/cm³ to 4 g/cm³. In particularly preferred embodiments, the opacifying mineral has a density of from 1.6 g/cm³ to 3.0 g/cm³. It has been found that the composition is particularly storage-stable when the composition comprises an opacifying mineral of said density.

The term “microfibrous cellulose”, also referred to as “microfibrillated cellulose” or “nanofibrillated cellulose” (NFC), relates to and includes cellulose fibers made by microbial fermentation, cellulose fibers made by mechanically disrupting, altering, or separating the fibers from cereal, wood, wood pulp, or cotton, or both cellulose fibers made by microbial fermentation and mechanical disruption, alteration, or separation. MFC as well as the preparation thereof is described inter alia in the Review article “Microfibrillated cellulose—its barrier properties and applications in cellulosic materials: A review”, Lavoine et al., Carbohydrate Polymers, 2012, pp. 735-764. The mechanical treatment of cellulose to produce MFCs can comprise the use of homogenizers, microfluidizers, grinders, or cryocrushing devices.

As discussed above, it is difficult to stabilize mineral dispersions, especially in liquid home and personal care compositions. In this respect, it has been found that the microfibrous cellulose not only stabilizes compositions, but provides stabilization at high temperatures and for extended storage times.

In an embodiment, the microfibrous cellulose is produced from bacteria of the family Acetobacteraceae, preferably from the genus Komagataeibacter, such as K. cocois, K. disospyri, K. europaeus, K. hansenii, K. intermedius, K kakiaceti, K. kombuchae, K. maltaceti, K. medellinensis, K. melaceti, K. nataicola, K. oboediens, K. pomaceti, K. rhaeticus, K. saccharivorans, K. sucrofermentans, K. swingsii, or K. xylinus.

In a particular preferred embodiment, the microfibrous cellulose is produced from Komagataeibacter strain ATC301. In an embodiment, the microfibrous cellulose comprises cellulose fibers having an average diameter of 1 nm to 1000 nm, preferably 20 nm to 500 nm. In certain embodiments, the microfibrous cellulose comprises cellulose fibers having an average diameter of 10 nm to 500 nm, preferably of 50 nm to 250 nm.

In an embodiment, the microfibrous cellulose has a fiber length of from 1 μm to 1000 μm, preferably from 1 μm to 100 μm.

The microfibrous cellulose can be added to the composition in any form, including as a powder, wet cake, or as a dispersion. When added as a dispersion, the microfibrous cellulose can be dispersed in water along with activating agents. In general, the compositions can have anywhere from 0.001 wt. % to 5 wt. %, preferably 0.01 wt. % to 4 wt. % of the microfibrous cellulose. In certain embodiments, the compositions can have 0.001 wt. % to 0.2 wt. %, preferably 0.01 wt. % to 0.15 wt. %, more preferably 0.03 wt. % to 0.1 wt. % of the microfibrous cellulose. In other embodiments, the compositions can have 0.2 to 2 wt. %, preferably 0.4 wt. % to 1.5 wt. %, more preferably 0.5 wt. % to 1.2 wt. % of the microfibrous cellulose.

With respect to the optional surfactant that may be present in the compositions, in general any surfactant or combination of surfactants can be used. In this respect, the surfactant can include any compound or compounds that decrease the surface tension between one or more components in the composition. In preferred embodiments, the surfactant can inhibit or prevent the sedimentation or flocculation of the opacifying mineral.

In certain embodiments, the surfactant can be a polymer, and in other embodiments, the surfactant can be a polymer in combination with another surfactant that is not a polymer. That is, the surfactant can be a polymer, a non-polymeric surfactant, or combinations thereof.

Surfactants include, but are not limited to, (i) an anionic surfactant, (ii) an amphoteric surfactant; (iii) a cationic surfactant; (iv) a nonionic surfactant, and (v) combinations thereof. In certain preferred embodiments, the surfactants can include an anionic surfactant, an amphoteric surfactant, a nonionic surfactant, and combinations thereof. Polymer surfactants include, but are not limited to polymers having a hydrophobic backbone and hydrophilic sidechains or vice versa. Non-limiting examples of polymer surfactants are polyacrylates, including polyacrylic acid and polyacrylate copolymers, polyvinylpyrrolidones, vinylpyrrolidone/vinyl ester copolymers, cellulose ethers, polyvinyl alcohols, polyalkylene glycols, and combinations thereof.

Suitable surfactants are described in “Surfactants and Interfacial Phenomena”, M. Rosen et al., Wiley, 2012 and “Applied Surfactants”, T. Tadros, Wiley-VCH, 2005.

In an embodiment, the anionic surfactant is selected from alkyl glycinates, alpha olefin sulphonates, alkyl sulfosuccinates, alkyl sulfo acetates, alkyl lactylates, alkyl carboxylates, alkoxy carboxylates, acyl glycinates, acyl taurates, acyl sarcosinates, acyl sulfates, acyl isethionates, acyl alaninates, sulphated linear alcohol ethoxylates, polyoxyethylene trialkyl phosphate esters, polyoxyethylene trialkyl ether phosphates and combinations thereof. In a preferred embodiment, the anionic surfactant is an alpha olefin sulphonate an alkyl glycinates, and combinations thereof.

The term “alkyl” preferably refers to a C₄-C₂₆ alkyl, more preferably to a C₁₂-C₁₈ alkyl. The term “acyl” preferably refers to a C₄-C₂₆ acyl, more preferably to a C₁₂-C₁₈ acyl. The term “alpha olefin” preferably refers to a C₄-C₂₆ alpha olefin, more preferably to a C₁₂-C₁₈ alpha olefin.

Anionic surfactants dissociate in water to yield an anion and a cation in water. In a solid composition, the anionic surfactant is a charge-neutral compound in the form of the free acid or a cosmetically acceptable salt thereof. Non-limiting examples of cosmetically acceptable salts are salts comprising ammonium, sodium, potassium and triethanolammonium.

Amphoteric surfactants have an anionic and a cationic functional group. In an embodiment, the amphoteric surfactant is selected from alkyl amido betaines, alkylamidopropyl betaines, alkyl betaines, alkylamidopropyl hydroxysultaines, alkyl hydroxysultaines, amphoacetate, alkyl amphoacetates, alkyl amphodiacetates, alkyl amphopropionates, alkyl amphodipropionates, aminopropionates, aminoglycinates, imidazolinium betaines, sulfobetaines, alkyl amine N-oxides, alkyldimethylamine N-oxides, alkylamidopropylamine N-oxides, and combinations thereof.

Cationic surfactants are positively charged at the polar end group, and can include, but art not limited to, quaternary ammonium surfactants and amine surfactants, such as amine alkoxylates.

Nonionic surfactants are preferably selected from alkanolamides, fatty alcohol, fatty alcohol ethoxylates, alkylphenol ethoxylates, glycerol fatty acid amides, glycerol fatty acid esters, sorbitol fatty acid esters, alkyl polyglucosides, and combinations thereof. Non-limiting examples of fatty alcohol ethoxylates are pentaethylene glycol monododecyl ether (also referred to as C12E5), hexaethylene glycol monododecyl ether (C12E6), heptaethylene glycol monododecyl ether (C12E7), and octaethylene glycol monodecyl ether (C12E8). Additional non-limiting examples of fatty alcohol ethoxylates include, but are not limited to, oleth-2, oleth-3, oleth-4, oleth-5, oleth-6, oleth-7, oleth-8, oleth-9, oleth-10, oleth-11, oleth-12, oleth-15, oleth-16, oleth-20, oleth-25, laureth-2, laureth-3, laureth-4, laureth-5, laureth-6, laureth-7, laureth-8, laureth-9, laureth-10, laureth-11, laureth-12, laureth-13, laureth-15, laureth-16, laureth-20, laureth-25, ceteth-10, ceteth-12, ceteth-14, ceteth-15, ceteth-16, ceteth-17, ceteth-20, ceteth-25, cetoleth-10, cetoleth-12, cetoleth-14, cetoleth-15, cetoleth-16, cetoleth-17, cetoleth-20, cetoleth-25, ceteareth-10, ceteareth-12, ceteareth-14, ceteareth-15, ceteareth-16, ceteareth-18, ceteareth-20, ceteareth-22, ceteareth-25, isosteareth-10, isosteareth-12, isosteareth-15, isosteareth-20, isosteareth-22, isosteareth-25, steareth-10, steareth-11, steareth-14, steareth-15, steareth-16, steareth-20, and steareth-25. Non-limiting examples of alkylphenol ethoxylates are Triton X-100® (octyl phenol ethoxylate) and Nonidet P-40® (4-nonylphenol ethoxylate). Non-limiting examples of alkanolamides are cocamide monoethanolamine and cocamide diethanolamine. Non-limiting examples of glycerol fatty acid esters are glycerol monostearate and glycerol monolaurate. Non-limiting examples of sorbitol fatty acid esters are sorbitan monolaurate, sorbitan monostearate and sorbitan tristearate.

In a preferred embodiment, the surfactant is selected from alcohol ethoxy carboxylates, disodium cocoampho diacetate, sodium cocoampho acetate, tetrasodium-N-(1,2-dicarboxyethyl)-N-octadecyl sulfosuccinamate, disodium laureth sulfosuccinate, polyoxyethylene tridecyl phosphate esters, polyoxyethylene tridecyl ether phosphates, sulfated linear alcohol ethoxylates, polyoxyethylene alkylethers, 2-[4-(2,4,4-trimethylpentan-2-yl) phenoxy]ethanol, and combinations thereof.

The opacifying mineral may belong to the group of phosphate minerals, silicate minerals, carbonate minerals, nitrate minerals, titanium minerals, and combinations thereof.

In a preferred embodiment, the opacifying mineral is selected from calcium carbonate, calcium citrate, boehmite, zeolite, alumina, diatome, calcined kaolin, talcum, barium sulfate, lanthanum phosphate, zirconium dioxide, hydroxyapatite, zinc sulfide, zinc oxide, silica, silicates, and combinations thereof. Hydroxyapatite is a naturally occurring mineral having the general formula Ca₅(PO₄)₃(OH). In a preferred embodiment, the hydroxyapatite not doped with any ions, i.e. the hydroxyapatite has less than 1 wt. % of its ions (Ca²⁺, PO₄³⁻ und OH⁻) replaced by different ions. The term “silica” includes silicates, such as inosilicates, phyllosilicates, and tectosilicates. Preferred silicates are phyllosilicates selected from clays and mica.

In a particularly preferred embodiment, the opacifying mineral is selected from mica, calcium carbonate, calcium citrate, and combinations thereof.

In an embodiment, the opacifying mineral has a volume-based particle size Dv50 ranging from 50 nm to 100 μm, preferably from 100 nm to 95 μm, more preferably from 500 nm to 90 μm. In certain embodiments, the opacifying mineral has a volume-based particle size Dv50 ranging from 100 nm to 20 μm, preferably from 500 nm to 15 μm. The opacifying mineral can also have a volume-based particle size Dv10 ranging from 10 nm to 75 μm, preferably from 20 nm to 50 μm, more preferably from 30 nm to 45 μm. The opacifying mineral can further have a volume-based particle size Dv90 ranging from 1 μm to 2000 μm, preferably from 5 μm to 1500 μm, more preferably from 10 μm to 1200 μm. Thus, the composition is a dispersion.

The volume-based particle sizes, including Dv10, Dv50, and Dv90 is preferably measured by laser diffraction using a laser diffraction particle size analyzer, such as an Mastersizer 300 from Malvern analytical.

In an embodiment, the composition is opaque. The term “opaque” with respect to the compositions, as opposed to only the opacifying mineral, refers to a composition having a whiteness ranging from 50 to 100, more preferably from 60 to 95. The whiteness is determined using the L*a*b* colour space. L* whiteness of a composition may be measured using the spectrocolorimeter DR LANGE LUCI 100 (measuring geometry d/8° acc. to DIN 5033). The plates that are used to measure L* whiteness consist of hexagonal shaped cells 2 cm wide by 3 mm thick. The sample quantity for each measurement is 1.5 mL per cell.

The composition can be provided in concentrated form (i.e., a concentrated formulation that can be diluted) or in the form of a diluted, ready-to-use cleaning formulation. In an embodiment, the composition is a concentrate, which can be suitable to be diluted to a cleaning formulation. In this respect, in certain embodiments the composition can comprise 0 wt. % to 25 wt. %, preferably 0.5 wt. % to 25 wt. %, more preferably 0.7 wt. % to 1.5 wt. % of a surfactant, 0.2 to 2 wt. %, preferably 0.4 wt. % to 1.5 wt. %, more preferably 0.5 wt. % to 1.2 wt. % of microfibrous cellulose, and 1 wt. % to 40 wt. %, preferably 5 wt. % to 30 wt. %, more preferably 10 wt. % to 20 wt. % of an opacifying mineral.

In an embodiment, the composition is a cleaning formulation that is ready-to-use. In other words, the composition can be used without being diluted or further modified. In this respect, in certain embodiments the composition can comprise 0 wt. % to 20 wt. %, preferably 0 wt. % to 5 wt. %, more preferably more than 0 wt. % to 5 wt. % of a surfactant, 0.001 wt. % to 0.2 wt. %, preferably 0.01 wt. % to 0.15 wt. %, more preferably 0.03 wt. % to 0.1 wt. % of microfibrous cellulose, and 0.05 wt. % to 20 wt. %, preferably 0.1 wt. % to 10 wt. %, more preferably 0.4 wt. % to 2 wt. % of an opacifying mineral. Such a ready-to-use composition can be consumer end products. The consumer end-product can be prepared by diluting the concentrate with aqueous solvents, liquids, or both, as well as non-aqueous solvents, liquids, or both. Further, both aqueous and non-aqueous solvents and liquids can be used to dilute the concentrate.

The composition of the present invention can generally be aqueous or non-aqueous. In embodiments in which the compositions are aqueous, the compositions can comprise more than 10 wt. % to 99 wt. % of water. In certain embodiments, and in particular with respect to consumer end-products, the compositions may comprise more than 10 wt. % to 95 wt. %, more than 10 wt. % to 80 wt. %, 20 wt. % to 70 wt. %, or 30 wt. % to 60 wt. % of an aqueous liquid, such as water. In an embodiment, the compositions can comprise an organic solvent selected from diols, including glycols. In certain preferred embodiments, the glycols are aliphatic glycols, including but not limited to ethylene glycol, propane-1,2-diol, propane-1,3-diol, butylene-1,2-diol, butylene, 1,3-diol, butylene-2,3-diol, neopenthyl glycol, diethylene glycol, dipropylene glycol, dibutylene glycol, methylglycol, polyethylene glycol, and combinations thereof. In some embodiments, the composition can comprises 1 wt. % to 95 wt. % of the organic solvent, preferably 3 wt. % to 60 wt. % of the organic solvent, more preferably 5 wt. % to 30 wt. % of the organic solvent. In other embodiments, the compositions can comprise 0.01 wt. % to 30 wt. %, preferably 0.1 wt. % to 25 wt. %, more preferably 0.5 wt. % to 20 wt. % of the organic solvent.

In certain embodiments, the composition does not comprise water or comprises only minimal amounts of water, such as 10 wt. % or less of water, 8 wt. % or less of water, 5 wt. % or less of water, or 1 wt. % or less of water. In certain embodiments, the compositions are non-aqueous.

In preferred embodiments, the composition of the present invention is a stable suspension. In certain embodiments, the term stable refers to a storage stability of at least 1 week at 24° C., preferably the term refers to a storage stability of at least 1 month at 40° C., more preferably 3 months at 40° C., wherein no sedimentation or flocculation can visually be detected. Put differently, the term “stable” means that the absorption coefficient at 550 nm of the composition does not change under storage for at least 1 week at 24° C., preferably the term refers to a storage stability of at least 1 month at 40° C., more preferably the term refers to a storage stability of at least 3 months at 40° C. Additionally, in certain embodiments, the term “stable” means that the whiteness determined by using the L*a*b* colour space, as described above, does not decrease more than 15%, preferably does not decrease more than 10%, more preferably does not decrease more than 5% under storage for at least 1 week at 24° C., preferably the term “stable” means that the whiteness determined by using the L*a*b* colour space, as described above, does not decrease more than 15%, preferably does not decrease more than 10%, more preferably does not decrease more than 5% under storage for at least 1 month at 40° C., and more preferably the term “stable” means that the whiteness determined by using the L*a*b* colour space, as described above, does not decrease more than 15%, preferably does not decrease more than 10%, more preferably does not decrease more than 5% under storage for at least 3 months at 40° C. In certain preferred embodiments, the term also means that no sedimentation or flocculation can visually be detected along with not decreasing the whiteness more than described above.

The present invention further relates to the use of composition as a cleaning composition, preferably as liquid laundry composition, single unit dose, liquid laundry detergent composition, dishwashing composition, personal care composition (preferably as a body cleaning composition, facial cleaning composition, shampoo, skin composition, or combination thereof), disinfection composition, floor cleanser, toilet bowl cleanser, glass cleanser, or combinations thereof.

### Examples

Examples 1 to 9 are directed to compositions containing the components as per Table 1. The compositions were prepared by adding the detergent (UCD-Ultra Concentrated Detergent), the microfibrous cellulose as a dispersion, produced from Komagataeibacter bacteria (MFC), and the surfactant in a non-aqueous solvent in a glass beaker and slowly adding the powder into the beaker at an agitation speed of 150 rpm. After complete addition of the powder, the suspension was stirred at 150 rpm for an additional 15 minutes. The dispersion was transferred into a glass bottle and stored at 24° C. or 40° C. The particle size distribution was measured using a Mastersizer 300 laser diffraction particle size analyzer from Malvern analytical.

The opacifying effect as well as the stability were visually evaluated and the results are stated in Table 1. “Fail” denotes phase separation during the storage testing.

TABLE 1
Examples 1 to 9

| Example (E)^{††} | E1 | E2 | E3 | E4 | E5 | E6 | E7 | E8 | E9 |
|---|---|---|---|---|---|---|---|---|---|
| Opacifying mineral powder | Talcum | Calcined | Silica | Mica | CaCO₃ | CaCO₃ | Ca₃- | BaSO₄ | ZrO₂ |
| | | Kaolin | | | | | citrate | | |
| Refractive index of the | 1.54 | 1.55 | 1.46 | 1.56 | 1.65 | 1.65 | 1.51 | 1.64 | 2 |
| opacifying mineral | | | | | | | | | |
| Density of the opacifying | 2.76 | 2.63 | 2.2 | 2.7 | 2.9 | 2.9 | 1.63 | 4.5 | 5.9 |
| mineral | | | | | | | | | |
| wt. % of opacifying mineral | 1 | 1 | 1 | 1 | 1 | 0.5 | 0.5 | 0.5 | 0.5 |
| powder | | | | | | | | | |
| wt. % of solvent and | 5.00 | 5.00 | 5.00 | 5.00 | 5.00 | 5.50 | 5.50 | 5.50 | 5.50 |
| surfactant | | | | | | | | | |
| wt. % of UCD | 90 | 90 | 90 | 90 | 90 | 90 | 90 | 90 | 90 |
| wt. % of MFC dispersion^{†} | 4.00 | 4.00 | 4.00 | 4.00 | 4.00 | 4.00 | 4.00 | 4.00 | 4.00 |
| Dv10 of opacifying mineral | 1.82 | 0.88 | 5.88 | 3.32 | 1.12 | 40.2 | 18.1 | 28.5 | 0.0375 |
| powder (μm) | | | | | | | | | |
| Dv50 of powder (μm) | 6.75 | 2.56 | 13.8 | 10.2 | 3.7 | 74.6 | 88.5 | 84.2 | 8.91 |
| Dv90 of opacifying mineral | 13.4 | 7.43 | 40.1 | 22.2 | 10.3 | 124 | 168 | 167 | 93 |
| powder (μm) | | | | | | | | | |
| Opacifying effect | Yes | Yes | Yes | Yes | Yes | Yes | Yes | Yes | Yes |
| Stability 1 day, 24° C. | Good | Good | Good | Good | Good | Good | Good | Good | Good |
| Stability 2 days, 24° C. | Good | Good | Good | Good | Good | Good | Good | Good | Good |
| Stability 4 days, 24° C. | Good | Good | Good | Good | Good | Good | Good | Good | Good |
| Stability 1 week, 24° C. | Good | Good | Good | Good | Good | Good | Good | Good | Good |
| Stability 1 month, 24° C. | Fail | Fail | Fail | Fail | Good | Good | Good | Fail | Fail |
| Stability 1 week, 40° C. | — | — | — | — | Good | Good | Good | Good | Good |
| Stability 1 month, 40° C. | — | — | — | — | Good | Good | Good | Fail | Fail |
| Stability 3 months, 40° C. | — | — | — | — | Good | Good | Good | — | — |

^{†}The MFC dispersion contains water, activating agents, and about 1.5 wt. % microfibrous cellulose.
^{††}The Examples contain about 0.06 wt. % of microfibrous cellulose.

It can be seen that all compositions of the present invention have opacifying properties and are stable, i.e. no phase separation occurs for an extended period of time at 24° C. In addition, Examples 5-7 are even stable at 40° C. for at least 3 months.

Comparative Examples 1 to 7 are directed to compositions containing the components as per Table 2. The compositions were prepared based on the protocol described above for Examples 1 to 9. Opulyn™ 301 contains polymer (styrene acrylate copolymer) particles as opacifier. The particle size distribution was measured using a Mastersizer 300 laser diffraction particle size analyzer from Malvern analytical.

It can be seen that the solid compositions without the MFC exhibit poor storage stability and phase separation occurs.

TABLE 2
Comparative Examples 1 to 7

| Comparative Example (CE) | CE1 | CE2 | CE3 | CE4 | CE5 | CE6 | CE7 |
|---|---|---|---|---|---|---|---|
| Opacifying mineral | Opulyn ™ | Opulyn ™ | Talcum | Calcined | Silica | Mica | CaCO₃ |
| powder | 301 | 301 | | Kaolin | | | |
| Refractive index of the | — | — | 1.54 | 1.55 | 1.46 | 1.56 | 1.65 |
| opacifying mineral | | | | | | | |
| Density of the opacifying | — | — | 2.76 | 2.63 | 2.2 | 2.7 | 2.9 |
| mineral | | | | | | | |
| wt. % of the opacifying | 1 | 1 | 1 | 1 | 1 | 1 | 1 |
| mineral powder | | | | | | | |
| wt. % of solvent and | — | 5 | — | — | — | — | — |
| surfactant | | | | | | | |
| wt. % of UCD | 99 | 90 | 99 | 99 | 99 | 99 | 99 |
| wt. % of MFC dispersion | — | 4 | — | — | — | — | — |
| Dv50 of powder (μm) | 0.17 | 0.17 | 6.75 | 2.56 | 13.8 | 10.2 | 2.69 |
| Opacifying effect | Reference | Reference | Yes | Yes | Yes | Yes | Yes |
| Stability 1 day, 24° C. | Good | Good | Fail | Fail | Good | Fail | Good |
| Stability 2 days, 24° C. | Good | Good | — | — | Good | — | Good |
| Stability 4 days, 24° C. | Fail | Good | — | — | Good | — | Good |
| Stability 1 week, 24° C. | — | Good | — | — | Fail | — | Fail |
| Stability 1 month, 24° C. | — | Fail | — | — | — | — | — |
| Stability 1 week, 40° C. | — | — | — | — | — | — | — |
| Stability 1 month, 40° C. | — | — | — | — | — | — | — |
| Stability 3 months, 40° C. | — | — | — | — | — | — | — |

Examples 10 to 13 and Comparative Examples 8 and 9 are directed to the compositions as per Table 3 below.

Comparative Example 8 corresponds to a 100% Solvay single unit dose (“SUD”).

The Solvay SUD formulation comprises 20 wt. % Rhodacal SSA/R, 20 wt. % Rhodasurf L7 AP, 10 wt. % Rhodapex ESB70R, 10 wt. % lauric acid, 8 wt. % monoethanolamine, 5 wt. % glycerol, 22 wt. % propylene glycol and 5 wt. % water.

Examples 10 to 13 and Comparative Example 9 were prepared by adding the Solvay SUD in a glass beaker and subsequently slowly adding the powder, the surfactant and a non-aqueous solvent, and a microfibrous cellulose dispersion containing about 0.06 wt. % of microfibrous cellulose in water with activating agents in which the microfibrous cellulose is produced from Komagataeibacter bacteria into the beaker at an agitation speed of 600 rpm. After complete addition of the powder, the suspension was stirred at 800 rpm for an additional 30 minutes. The opacity, viscosity and particle size distribution were then measured.

The viscosity was measured using a Brookfield DV3T Extra LVT rheometer using a spindle 63 at shear rates from 0.1 to 50 rpm.

The particle size distribution was measured using a Mastersizer 300 laser diffraction particle size analyzer from Malvern analytical.

The whiteness ΔL was determined using the L*a*b* colour space. L* whiteness of a composition was measured using the spectrocolorimeter DR LANGE LUCI 100 (measuring geometry d/8° acc. to DIN 5033).

The whiteness ΔE was determined for each example (i.e., Examples 10-13) and both comparative examples (i.e., Comparative Examples 8 and 9) by the following formula:

$$Δ {E}_{a b}^{*} = {[ {( Δ {L}^{*} )}^{2} + {( Δ {a}^{*} )}^{2} + {( Δ {b}^{*} )}^{2} ]}^{1 / 2}$$

wherein ΔL*, Δa*, and Δb* are determined based on measuring the L*, a*, and b* of the SUD alone (without the opacifying mineral powder, MFC dispersion, and the solvent and surfactant) which is the reference, and then measuring the L*, a*, and b* for each example and comparative example (i.e., the SUD with the opacifying mineral powder, MFC dispersion, and the solvent and surfactant). Accordingly, the ΔL*=L* (only the SUD before adding the opacifying mineral powder, MFC dispersion, and the solvent and surfactant)−L* (the SUD after adding the opacifying mineral powder, MFC dispersion, and the solvent and surfactant). Similarly, Δa=a* (only the SUD before adding the opacifying mineral powder, MFC dispersion, and the solvent and surfactant)−a* (the SUD after adding the opacifying mineral powder, MFC dispersion, and the solvent and surfactant), and Δb=b* (only the SUD before adding the opacifying mineral powder, MFC dispersion, and the solvent and surfactant)−b* (the SUD after adding the opacifying mineral powder, MFC dispersion, and the solvent and surfactant). An Agera Spectrophotometer available from HunterLab was used.

It can be seen from Table 3 that the Examples 10 to 13 resulted in an opaque composition. In addition, the change in viscosity at different shear rates is smaller than in the Comparative Examples.

TABLE 3
Examples 10 to 13 and Comparative Examples 8 and 9

| Example (E)^{††} or Comparative | | | | | | |
|---|---|---|---|---|---|---|
| Example (CE) | E10 | E11 | E12 | E13 | CE8 | CE9 |
| Opacifying mineral powder | BaSO₄ | ZrO₂ | Ca₃Citrate | CaCO₃ | — | Opulyn ™ |
| | | | | | | 301 |
| Refractive index of the | 1.64 | 2 | 1.51 | 1.65 | 1.4475 | — |
| opacifying mineral | | | | | | |
| Density of the opacifying mineral | 4.5 | 5.9 | 1.63 | 2.9 | — | — |
| wt. % of the opacifying mineral | 0.5% | 0.5% | 0.5% | 0.5% | — | 0.5% |
| powder | | | | | | |
| wt. % of MFC dispersion^{†} | 4% | 4% | 4% | 4% | — | 4% |
| wt. % solvent and surfactant | 5.5% | 5.5% | 5.5% | 5.5% | — | 5.5% |
| wt. % of SUD | 90% | 90% | 90% | 90% | 100% | 90% |
| particle size Dv(50) um | 8.91 | 84.2 | 88.5 | 74.6 | — | — |
| Whiteness (opacity) ΔL | 57.4 | 55.95 | 59.16 | 73.44 | 0 | 67.25 |
| Whiteness (opacity) ΔE | 57.89 | 56.38 | 59.57 | 73.81 | 0 | 67.39 |
| Viscosity at 0.1 rpm, cP · s | 24000 | 14400 | 26400 | 24000 | 1200 | 19200 |
| Viscosity at 0.5 rpm, cP · s | 12000 | 8880 | 14400 | 13200 | 240 | 12240 |
| Viscosity at 1.0 rpm, cP · s | 6720 | 5640 | 8640 | 7680 | 240 | 7320 |
| Viscosity at 10.0 rpm, cP · s | 1224 | 1044 | 1536 | 1416 | 180 | 1128 |
| Viscosity at 50.0 rpm, cP · s | 516 | 465.6 | 657.6 | 687.2 | 175.2 | 463.2 |

^{†}The MFC dispersion contains water, activating agents, and about 1.5 wt. % of microfibrous cellulose.
^{††}The Examples and Comparative Example 9 contain about 0.06 wt. % of microfibrous cellulose.

Examples 14 to 19 are directed to the compositions as per Table 5 below. These Examples were prepared by adding commercially available OMO® single unit doses laundry capsules in a glass beaker and subsequently slowly adding microfibrous cellulose produced from Komagataeibacter bacteria into the beaker at an agitation speed of 600 rpm. Subsequently, the respective opacifying mineral dispersions A-F (see Table 4 below) were added at an agitation speed of 800 rpm. After complete addition of the opacifying mineral premix dispersion, the mixture was stirred at 800 rpm for an additional 30 minutes. The viscosity and particle size distribution was then determined as described above.

TABLE 4
Opacifying Mineral Dispersions A-F (values refer to wt.)

| Example | A | B | C | D | E | F |
|---|---|---|---|---|---|---|
| CaCO₃ | 50% | 50% | 50% | | | |
| Ca₃Citrate | | | | 33.34% | 33.34% | 33.34% |
| Propylene | 21.22% | 20.54% | 22.27% | 28.29% | 27.38% | 29.69% |
| glycol | | | | | | |
| Glycerol | 21.22% | 20.54% | 22.27% | 28.29% | 27.38% | 29.69% |
| Decanoic | | | | | | |
| acid | | | | | | |
| Octanoic acid | | | | | | |
| Citric acid | 3.21% | 3.21% | 3.21% | 4.28% | 4.28% | 4.28% |
| (50% aq.) | | | | | | |
| Miranate B | 4.35% | | | 5.80% | | |
| (46% aq.) | | | | | | |
| Aerosol 22 | | 5.71% | | | 7.62% | |
| (35%) | | | | | | |
| Geropon | | | 2.25% | | | 3% |
| HW15 (89%) | | | | | | |
| Dv(50)* μm | 3.51 | 3.62 | 3.66 | 7.07 | 8.74 | 6.33 |

*Dv50 was measured as described above.

TABLE 5
Examples 14 to 19

| Example (E)^{††††} | E14 | E15 | E16 | E17 | E18 | E19 |
|---|---|---|---|---|---|---|
| OMO ® | 136 | 136 | 136 | 136 | 136 | 136 |
| Single Unit | | | | | | |
| Dose (g) | | | | | | |
| Propylene | 6 | 6 | 6 | 6 | 6 | 6 |
| glycol (g) | | | | | | |
| MFC | 6 | 6 | 6 | 6 | 6 | 6 |
| dispersion | | | | | | |
| (g)^{†††} | | | | | | |
| Opacifying | 3 | | | | | |
| Mineral | | | | | | |
| Dispersion A | | | | | | |
| (g) | | | | | | |
| Opacifying | | 3 | | | | |
| Mineral | | | | | | |
| Dispersion B | | | | | | |
| (g) | | | | | | |
| Opacifying | | | 3 | | | |
| Mineral | | | | | | |
| Dispersion C | | | | | | |
| (g) | | | | | | |
| Opacifying | | | | 3 | | |
| Mineral | | | | | | |
| Dispersion D | | | | | | |
| (g) | | | | | | |
| Opacifying | | | | | 3 | |
| Mineral | | | | | | |
| Dispersion E | | | | | | |
| (g) | | | | | | |
| Opacifying | | | | | | 3 |
| Mineral | | | | | | |
| Dispersion F | | | | | | |
| (g) | | | | | | |
| Dv(50) μm* | 3.7 | 3.86 | 3.66 | 11.7 | 9.5 | 13.5 |
| Viscosity at | 46800 | 57600 | 50400 | 51600 | 39600 | 45600 |
| 0.1 rpm, cP · s | | | | | | |
| Viscosity at | 32400 | 32880 | 31920 | 31400 | 27360 | 30960 |
| 0.5 rpm, cP · s | | | | | | |
| Viscosity at | 16680 | 18120 | 18240 | 17040 | 14640 | 17280 |
| 1.0 rpm, cP · s | | | | | | |
| Viscosity at | 2868 | 3492 | 3432 | 2772 | 2508 | 3168 |
| 10.0 rpm, | | | | | | |
| cP · s | | | | | | |
| Viscosity at | 1274 | 1694 | 1656 | 1246 | 1171 | 1514 |
| 50.0 rpm, | | | | | | |
| cP · s | | | | | | |

*Dv50 was measured as described above.
^{†††}The MFC dispersion contains water, activating agents, and about 1.6 wt. % of microfibrous cellulose.
^{††††}The Examples contain about 640 ppm of microfibrous cellulose.

1. A composition comprising:
(a) an opacifying mineral having a refractive index of at least 1.40 and a density of 1.5 g/cm³ to 6 g/cm³;
(b) microfibrous cellulose; and
(c) optionally a surfactant.

2. The composition according to claim 1, wherein the opacifying mineral is selected from calcium carbonate, calcium citrate, boehmite, zeolite, alumina, diatome, calcined kaolin, talcum, barium sulfate, lanthanum phosphate, zirconium dioxide, hydroxyapatite, zinc sulfide, zinc oxide, silica, and combinations thereof.

3. The composition according to claim 1, wherein the opacifying mineral has a volume-based particle size Dv50 ranging from 100 nm to 20 μm.

4. The composition according to claim 1, wherein the microfibrous cellulose is obtained from bacteria, wood, or wood pulp.

5. The composition according to claim 1, wherein the composition is opaque.

6. The composition according to claim 1, wherein the composition comprises:
(a) 1 wt. % to 40 wt. % of the opacifying mineral;
(b) 0.2 to 2 wt. % of the microfibrous cellulose; and
(c) 0 wt. % to 25 wt. % of the surfactant,
wherein all weight percentages are based on a total weight of the composition.

7. The composition according to claim 1, wherein the composition comprises:
(a) 0.05 wt. % to 20 wt. % of the opacifying mineral;
(b) 0.001 wt. % to 0.2 wt. % of the microfibrous cellulose; and
(c) 0 wt. % to 20 wt. % of the surfactant,
wherein all weight percentages are based on a total weight of the composition.

8. The composition according to claim 1, wherein the microfibrous cellulose comprises cellulose fibers having an average diameter of 1 nm to 1000 nm.

9. The composition according to claim 1, wherein the surfactant is a polymer.

10. The composition according to claim 1, wherein the surfactant comprises:
(i) an anionic surfactant selected from alkyl glycinates, alpha olefin sulphonates, alkyl sulfosuccinates, alkyl sulfo acetates, alkyl lactylates, alkyl carboxylates, alkoxy carboxylates, acyl glycinates, acyl taurate, acyl sarcosinates, acyl sulfates, acyl isethionates, acyl alaninates, sulphated linear alcohol ethoxylates, polyoxyethylene trialkyl phosphate esters, polyoxyethylene trialkyl ether phosphates, and combinations thereof;
(ii) an amphoteric surfactant selected from alkyl amido betaines, alkylamidopropyl betaines, alkyl betaines, alkylamidopropyl hydroxysultaines, alkyl hydroxysultaines, amphoacetate, alkyl amphoacetates, alkyl amphodiacetates, alkyl amphopropionates, alkyl amphodipropionates, aminopropionates, aminoglycinates, imidazolinium betaines, sulfobetaines, alkyl amine N-oxides, alkyldimethylamine N-oxides, alkylamidopropylamine N-oxides, and combinations thereof;
(iii) a nonionic surfactant selected from alkanolamides, fatty alcohol, fatty alcohol ethoxylates, alkylphenol ethoxylates, glycerol fatty acid amides, glycerol fatty acid esters, sorbitol fatty acid esters, alkyl polyglucosides, and combinations thereof; and
(iv) combinations of (i)-(iii).

11. The composition according to claim 1, wherein the surfactant is selected from alcohol ethoxy carboxylates, disodium cocoampho diacetate, sodium cocoampho acetate, tetrasodium-N-(1,2-dicarboxyethyl)-N-octadecyl sulfosuccinamate, disodium laureth sulfosuccinate, polyoxyethylene tridecyl phosphate esters, polyoxyethylene tridecyl ether phosphates, sulfated linear alcohol ethoxylates, polyoxyethylene alkylethers, 2-[4-(2,4,4-trimethylpentan-2-yl) phenoxy]ethanol, and combinations thereof.

12. The composition according to claim 1, wherein the composition comprises more than 10 to 95 wt. % of water based on a total weight of the composition.

13. The composition according to claim 1, wherein the composition comprises 10 wt. % or less of water based on a total weight of the composition.

14. The composition according to claim 1, wherein the composition is a stable suspension.

15. The composition according to claim 1, wherein the refractive index of the opacifying mineral is measured in accordance with GB/T 16863-1997.

16. The composition according to claim 1, wherein the density of the opacifying mineral is measured in accordance with ASTM D 5965-19.

17. A cleaning composition comprising the composition of claim 1.

18. The composition according to claim 1, wherein the opacifying mineral has a density of 1.5 g/cm³ to 4 g/cm³.

19. The composition according to claim 1, wherein the microfibrous cellulose comprises cellulose fibers having an average diameter of 20 nm to 500 nm.

20. The cleaning composition of claim 17, wherein the cleaning composition is a disinfection composition, floor cleanser, toilet bowl cleanser, glass cleanser, liquid laundry composition, liquid laundry detergent composition, dishwashing composition, personal care composition, facial cleaning composition, shampoo, skin composition, or combinations thereof.
